(19) United States
(12) Patent Application Publication
(10) Pub. No.: US 2012/0293766 A1
(43) Pub. Date: Nov. 22, 2012

(54) Foldable Sunglasses

(76) Inventor: Roland Alexander Pitcairn, Boulder, CO (US)

(21) Appl. No.: 13/109,844

(22) Filed: May 17, 2011

(51) Int. Cl. G02C 5/08; G02C 7/10

(52) U.S. Cl. 351/44; 351/63

(57) ABSTRACT

The present invention relates to foldable eyeglasses. The foldable eyeglasses include a first frame member and a second frame member, where each frame member holds a lens, and a first hinge that connects the first and second frame members. The foldable eyeglasses also include a first temple member and a second temple member, where each includes a plurality of foldable or collapsible segments, and first and second temple member hinges, where the first temple member hinge connects the first temple member to the first frame member, and the second temple member hinge connects the second temple member to the second frame member. The first and second frame members and the first and second temple members can fold at each of the first hinge and the first and second temple member hinges, such that the foldable sunglasses can compact into a profile size similar to that of a standard credit card.

### BACKGROUND OF THE INVENTION

There are numerous examples of foldable glasses to make them more compact and easier to store. For example, U.S. Pat. Nos.: 5,532,766; 5,225,857; 5,208,616; 4,681,410; 4,720,186; 4,840,476 and 2,814,968 disclose a variety of folding eyeglass frames. The '766 patent discloses a detent based locking mechanism for locking a foldable pair of eyeglasses into place. The '857 patent shows collapsible eyeglasses with a mechanism for collapsing the nose pad members when not in use. The '616 patent shows folding spectacles with a hinged joint. The '410 patent shows foldable eyeglasses that can be closed and stored in the form of a money clip. The '186 patent shows folding reading glasses that can be collapsed and stored in a watch compartment. The '476 patent shows foldable reading glasses with pivoting lenses. The '968 patent shows a hinged folding eyeglass frame. However, these foldable eyeglasses are bulky and unsightly in comparison to conventional eyeglasses.

While the aforementioned designs present mechanisms for folding eyeglasses, none of them address the unique features and distinct characteristics of sunglasses. For example, each of the aforementioned designs is geared towards reading glasses, which utilize small lenses. These lenses can be small, because the wearer is focusing along a single line of vision, and is not concerned about the lack of a lens about the periphery. In contrast to this, the purpose of sunglasses is to block direct or reflected sunlight, such that the wearer is able to reduce glare. Reducing glare is important not only along a single line of sight, but also about the wearer's peripheral vision. To do this, the sunglass lenses are larger than those for reading glasses and/or include adjacent shielding components that project the wearer's eyes from the direct or reflected light.

Therefore, a need exists for a folding mechanism that addresses the particular features and functionality of sunglasses. The present invention fulfills this need.

### BRIEF SUMMARY OF THE INVENTION

The present invention relates to foldable eyeglasses. The foldable eyeglasses include a first frame member and a second frame member, where each frame member holds a lens, and a first hinge that connects the first and second frame members. The foldable eyeglasses also include a first temple member and a second temple member, where each includes a plurality of foldable or collapsible segments, and first and second temple member hinges, where the first temple member hinge connects the first temple member to the first frame member, and the second temple member hinge connects the second temple member to the second frame member. The first and second frame members and the first and second temple members can fold at each of the first hinge and the first and second temple member hinges, such that the foldable sunglasses can compact into a profile size similar to a standard credit card.

In one embodiment, the foldable eyeglasses are sunglasses. In another embodiment, the compacted profile size is about 84 mm×53 mm×3 mm. In another embodiment, the segments of each temple member are foldable at a hinge connected the segments. In another embodiment, the first and second temple members each include three segments. In another embodiment, two of the segments are about 50 mm and the third segment is about 38 mm. In another embodiment, each lens is about 50 mm×38.5 mm. In another embodiment, the segments of each temple member collapse via a telescoping mechanism. In another embodiment, the first and second frame members include a telescoping mechanism, such that the first and second frame members can elongate away from each other. In another embodiment, any one of the hinges includes a locking mechanism to temporarily lock the hinge in a configuration.

### BRIEF DESCRIPTION OF THE DRAWINGS

The following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings. In the drawings:

FIG. 1 is a perspective view depicting exemplary sunglasses in the unfolded or wearable conformation.

FIG. 2 is a perspective view of the sunglasses of FIG. 1 in a partially folded conformation.

FIG. 3A is a front view of the sunglasses of FIG. 1.

FIG. 3B is a top view of the sunglasses of FIG. 1.

FIG. 4A is a top view of the sunglasses of FIG. 1 in a fully folded conformation.

FIG. 4B is a side view or profile of the fully folded sunglasses of FIG. 4A.

FIG. 5A is a top view of a case for holding the sunglasses when in the fully folded conformation. FIGS. 5B and 5C are side view profiles of the case of FIG. 5A.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in folding eyewear or sunglasses, and the methods of manufacturing and using the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. Therefore, the disclosure herein is directed to all such variations and modifications to such elements and methods as would be understood by those skilled in the art. Furthermore, the embodiments identified and illustrated herein are for exemplary purposes only, and are not meant to be exclusive or limited in their description of the present invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Further, all numerical designations are approximations which may be varied (+) or (−) by increments of 0.1. It is to be understood, although not always explicitly stated that all numerical designations are preceded by the term “about”.

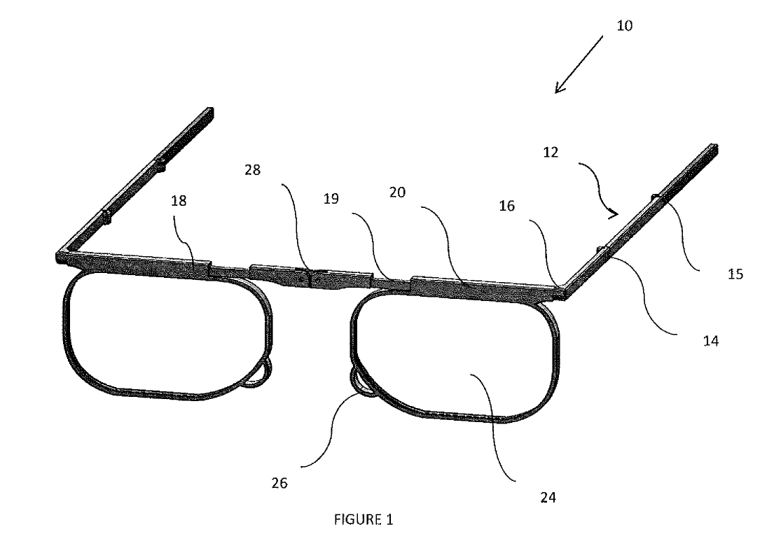

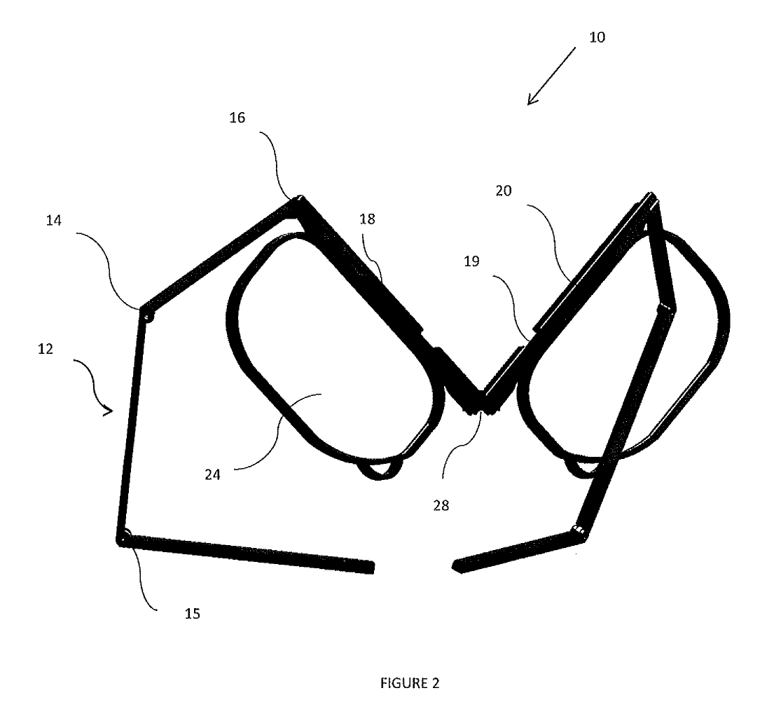

The present invention relates to sunglasses that can be uniquely folded into a compact conformation having the general profile of a standard sized credit card. For example, as shown in FIGS. 1 and 2, an exemplary embodiment of the invention is sunglasses 10, in an unfolded and wearable conformation (FIG. 1) and a partially folded conformation (FIG. 2). Sunglasses 10 may include two temple members 12, and first and second frame members 18, 20, each supporting a lens 24 and nose pad 26 (or other supportive surface, such a protruding frame ridge).

Each temple member 12 may consist of a plurality of segments, such that the segments may be collapsed into a more compacted conformation. For example, in the exemplary embodiment of FIGS. 1 and 2, temple member 12 may include three segments, where the segments are connected to each other at their ends by hinging regions 14 and 15. Temple members 12 are connected to frame members 18 and 20 via a hinging region 16. Hinging region 18 may provide hinged movement in the x/z plane, or alternatively or additionally, in the x/y plane. It should be appreciated that any number of temple member segments and hinging regions may be used. Alternatively, hinged regions 14 and 15 may be telescoping regions, such that the temple member segments fit within each other to collapse into the overall length of the longest segment. Additionally, the segments of temple member 12 may be substantially equal in length and/or width, or they may be of variable lengths and/or widths, provided the resulting compacted conformation remains in the general profile of a standard sized credit card. Further, temple member 12 may include any design or shape for fitting onto the wearer's ear, such as a hooked or bent region extending beyond the wearer's ear to provide a better fit or to better secure sunglasses 10 on the wearer.

Frame members 18 and 20 may each be constructed of a single segment, or they may include multiple segments with a hinging or telescoping region therebetween, as was described above for hinged regions 14 and 15. For example, as seen in FIG. 1, each of frame members 18 and 20 has a telescoping region 19 that allows the distance between lenses 24 to vary.

Sunglasses 10 also include hinged region 28, positioned between frame members 18 and 20, which may permit sunglasses 10 to fold in a variety of angles. For example, frame members 18 and 20, which are in line with each other when unfolded and in a wearable conformation, may fold upwards in the x/y plane at hinged region 28, such that frame members 18 and 20 are substantially parallel in the y direction and lenses 24 face outwards from folded members 18 and 20. Alternatively, frame members 18 and 20 may fold inwards in the x/z plane at hinged region 28, such that frame members 18 and 20 are substantially parallel in the z direction.

As contemplated herein, the temple member and frame member portions may be constructed of either a rigid or flexible material For example, the frame may be comprised of a stiff or flexible, resilient polymer material, natural or synthetic rubber, metal, foam or any other desired material. In some embodiments, all the component parts of temple members 12 and frame members 18 and 20 are composed of the same material. In other embodiments, selected components are composed of one material, while the remaining components are composed of another material. Similarly, selected components may be stiff or rigid, while other components are flexible. It should be appreciated that the present invention is not limited in the particular material or structural characteristics of stiffness or flexibility. While lenses 24 are presented herein as sunglass lenses, this is not required, as lenses 24 may comprise either sunglass lenses or non-sunglass lenses. Thus, lenses 24 may be clear, tinted, or photogray (darken in the presence of light). The lenses may comprise either prescription lenses or non-prescription lenses. Lenses 24 may also include a slight curvature, provided such curved lenses are suitable for the frames and lenses portions to be compacted into the size of a standard credit card.

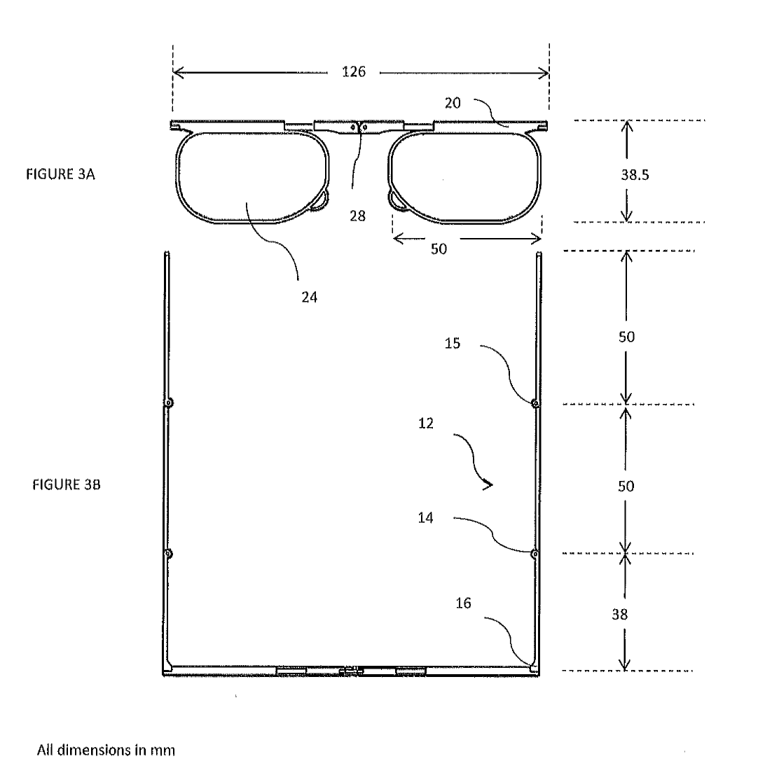

FIGS. 3A and 3B illustrate an exemplary embodiment of the present invention, wherein the various segment portions of the sunglasses are sized such that the sunglasses may be compacted to a profile similar to that of a standard credit card, which we generally define here as about 84 mm×53 mm×3 mm (the difference being that an actual credit card has a depth of closer to 1 mm). For example, as shown in FIG. 3A, each lens 24 may have a length of about 50 mm, and a height of about 38.5 mm. Frame members 18 and 20 may telescope away from each other, to expand the distance between hinging regions 16 to about 126 mm. As shown in FIG. 3B, temple members 12 have three segments, where two segments are about 50 mm each in length, and the third segment is about 38 mm in length. It should be appreciated that these segments, as well as frame members 18 and 20, can be any desired length, so long as the final combination of component lengths permits the sunglasses to be compacted into the profile size similar to that of a standard credit card.

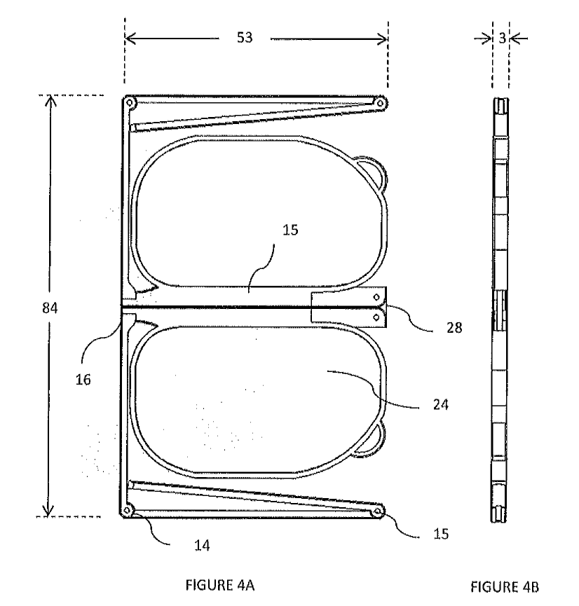

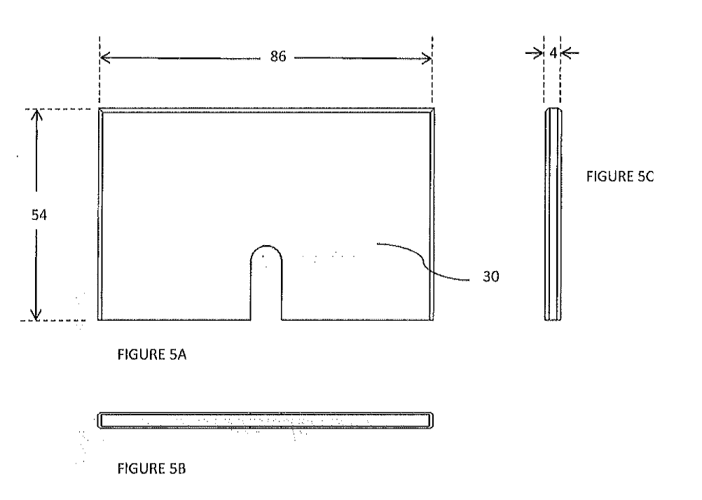

FIGS. 4A and 4B illustrate the sunglasses in a fully folded conformation. For example, as shown in FIGS. 4A and 4B, the sunglasses have been folded into a profile of about 84 mm×53 mm×4 mm. Likewise, the sunglasses being in the fully folded conformation of FIGS. 4A and 4B, may fit within case 30, as illustrated in FIG. 5. The dimensions of case 30 are approximately 86 mm×54 mm×4 mm.

As shown in FIG. 2, sunglasses 10 can fold or compact at any of the hinged regions to compact in a number of conformations, as desired by the user. In an exemplary method of the sunglasses of the present invention folding into the profile of a standard credit card, sunglasses 10 of FIG. 1 can be fully folded into the conformation of FIGS. 4A and 4B. For example, the segments of temple members 12 can each be folded at hinges 14 and 15, such that the segments wrap around lens 24. Frame members 18 and 20 can be compacted at telescoping regions 19 so as to be butting each other at hinging region 28. Next, the frame members 18 and 20 can be folded together at hinging region 28, such that frame members 18 and 20 are substantially lying alongside each other. It should be appreciated that the present invention contemplates the use of any folding scheme or mechanism, such that the fully folded sunglasses can be compacted into the profile of a standard sized credit card.

As contemplated herein, any hinge or telescoping mechanism may include a temporary locking mechanism as would be understood by those skilled in the art, such that the hinge or telescoping mechanisms can be temporarily secured in a desired position. Examples of such locking mechanisms may include the use of a detent and corresponding protrusion, or the use of a spring-loaded pin.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. Foldable eyeglasses, comprising:
a first frame member and a second frame member, each holding a lens;
a first hinge connecting the first and second frame members;
a first temple member and a second temple member, each comprising a plurality of foldable or collapsible segments; and
a first temple member hinge and a second temple member hinge, wherein the first temple member hinge connects the first temple member to the first frame member, and the second temple member hinge connects the second temple member to the second frame member;
wherein the first and second frame members and the first and second temple members can fold at each of the first hinge and the first and second temple member hinges, such that the foldable sunglasses can compact into a profile size similar to a standard credit card.

2. The foldable eyeglasses of claim 1, wherein the eyeglasses are sunglasses.

3. The foldable eyeglasses of claim 1, wherein the dimensions of the sunglasses when folded is about 84 mm×53 mm×3 mm.

4. The foldable eyeglasses of claim 1, wherein the segments of each temple member are foldable at a hinge connected the segments.

5. The foldable eyeglasses of claim 1, wherein the first and second temple members each include three segments.

6. The foldable eyeglasses of claim 5, wherein two of the segments are about 50 mm and the third segment is about 38 mm.

7. The foldable eyeglasses of claim 6, wherein each lens is about 50 mm×38.5 mm.

8. The foldable eyeglasses of claim 1, wherein the segments of each temple member collapse via a telescoping mechanism.

9. The foldable eyeglasses of claim 1, wherein the first and second frame members include a telescoping mechanism, such that the first and second frame members can elongate away from each other.

10. The foldable eyeglasses of claim 1, wherein any one of the hinges includes a locking mechanism to temporarily lock the hinge in a configuration.
